(19) United States
(12) Patent Application Publication
(10) Pub. No.: US 2018/0210713 A1
(43) Pub. Date: Jul. 26, 2018

(54) METHODS AND SYSTEMS FOR USING CROSS REPOSITORIES

(71) Applicant: salesforce.com, inc., San Francisco, CA (US)

(72) Inventor: Benjamin BUSJAEGER, San Carlos, CA (US)

(21) Appl. No.: 15/413,707

(22) Filed: Jan. 24, 2017

(51) Int. Cl. G06F 9/44; G06F 17/30

(52) U.S. Cl. CPC G06F 8/36; G06F 17/30545; G06F 17/30377; G06F 8/71

(57) ABSTRACT

Some embodiments of the present invention include receiving, by a server computing system, a first request from a client computing system for a first source code stored in a first central source repository and a second source code stored in a second central source repository; generating, by the server computing system, a combined source code using the first source code and the second source code, said generating being based on at least one dependency between a source code module in the first source code and a source code module in the second source code; and responding, by the server computing system, to the first request by transmitting one or more source code modules in the combined source code to the client computing system.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

The present disclosure relates generally to data processing and more specifically relates to application development.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

Application development may generally include making changes to existing applications by downloading the source code, editing the source code, compiling, and testing the resulting binary executable code. When the code base is large, it can take a developer a long time to go through the entire development process. In an environment where many developers are working on different modules of the same source code or even different modules of multiple source code, many hours are spent by all of the developers in the development process. Thus, it may be beneficial to develop techniques to make the development process more efficient.

### BRIEF SUMMARY

For some embodiments, methods and systems for performing a cross repository build are disclosed and may include receiving, by a server computing system, a first request from a client computing system for a first source code stored in a first central source repository and a second source code stored in a second central source repository; generating, by the server computing system, a combined source code using the first source code and the second source code, said generating being based on at least one dependency between a source code module in the first source code and a source code module in the second source code; and responding, by the server computing system, to the first request by transmitting one or more source code modules in the combined source code to the client computing system. Other aspects and advantages of the present invention can be seen on review of the drawings, the detailed description and the claims, which follow.

### BRIEF DESCRIPTION OF THE DRAWINGS

The included drawings are for illustrative purposes and serve only to provide examples of possible structures and process steps for the disclosed techniques. These drawings in no way limit any changes in form and detail that may be made to embodiments by one skilled in the art without departing from the spirit and scope of the disclosure.

FIG. 1 shows a diagram of an example computing system that may be used with some embodiments.

FIG. 2 shows a diagram of an example network environment that may be used with some embodiments.

FIG. 3A is an example diagram showing multiple source repositories and multiple central binary repositories, in accordance with some embodiments.

FIG. 3B is an example diagram showing several versions of the source code that may be stored in a source repository, in accordance with some embodiments.

FIG. 4A is an example diagram showing module dependency, in accordance with some embodiments.

FIG. 4B is an example of a dependency graph that includes modules from multiple central source repositories, in accordance with some embodiments.

FIG. 5A is an example diagram showing a virtual repository build module, in accordance with some embodiments.

FIG. 5B is an example diagram showing a difference determination module, in accordance with some embodiments.

FIG. 6A shows an example of changed data blocks in different source code modules, in accordance with some embodiments.

FIG. 6B shows an example of the downloading updates to the local source repository and local binary repository, in accordance with some embodiments.

FIGS. 7A and 7B show flowcharts of example processes for performing cross repository build, in accordance with some embodiments.

FIG. 8A shows a system diagram illustrating architectural components of an applicable environment, in accordance with some embodiments.

FIG. 8B shows a system diagram further illustrating architectural components of an applicable environment, in accordance with some embodiments.

FIG. 9 shows a system diagram illustrating the architecture of a multi-tenant database environment, in accordance with some embodiments.

FIG. 10 shows a system diagram further illustrating the architecture of a multi-tenant database environment, in accordance with some embodiments.

### DETAILED DESCRIPTION

Applications of systems and methods for performing cross repository builds are disclosed. Source code from multiple source repositories may be combined based on a request for each individual source code. The combining of the source code bases from the multiple source repositories may be based on at least one dependency of a source code module in one source code base and a source code module in another source code base.

The systems and methods will be described with reference to example embodiments. These examples are being provided solely to add context and aid in the understanding of the present disclosure. It will thus be apparent to one skilled in the art that the techniques described herein may be practiced without some or all of these specific details. In other instances, well known process steps have not been described in detail in order to avoid unnecessarily obscuring the present disclosure. Other applications are possible, such that the following examples should not be taken as definitive or limiting either in scope or setting.

In the following detailed description, references are made to the accompanying drawings, which form a part of the description and in which are shown, by way of illustration, specific embodiments. Although these embodiments are described in sufficient detail to enable one skilled in the art to practice the disclosure, it is understood that these examples are not limiting, such that other embodiments may be used and changes may be made without departing from the spirit and scope of the disclosure.

As used herein, the term “multi-tenant database system” refers to those systems in which various elements of hardware and software of the database system may be shared by one or more customers. For example, a given application server may simultaneously process requests for a great number of customers, and a given database table may store rows for a potentially much greater number of customers.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more embodiments may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

The disclosed embodiments may include systems and methods for performing cross repository build. The method includes receiving, by a server computing system, a first request from a client computing system for a first source code stored in a first central source repository and a second source code stored in a second central source repository; generating, by the server computing system, a combined source code using the first source code and the second source code, said generating being based on at least one dependency between a source code module in the first source code and a source code module in the second source code; and responding, by the server computing system, to the first request by transmitting one or more source code modules in the combined source code to the client computing system.

The disclosed embodiments may include an apparatus for performing cross repository builds and include a processor, and one or more stored sequences of instructions which, when executed by the processor, cause the processor to receive a first request from a client computing system for a first source code stored in a first central source repository and a second source code stored in a second central source repository; generate a combined source code using the first source code and the second source code, said generating being based on at least one dependency between a source code module in the first source code and a source code module in the second source code; and respond to the first request by transmitting one or more source code modules in the combined source code to the client computing system.

The disclosed embodiments may include a computer program product comprising computer-readable program code to be executed by one or more processors when retrieved from a non-transitory computer-readable medium, the program code including instructions to receive a first request from a client computing system for a first source code stored in a first central source repository and a second source code stored in a second central source repository; generate a combined source code using the first source code and the second source code, said generating being based on at least one dependency between a source code module in the first source code and a source code module in the second source code; and respond to the first request by transmitting one or more source code modules in the combined source code to the client computing system.

While one or more implementations and techniques are described with reference to an embodiment in which cross repository builds may be performed to enable using multiple source repositories is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

The described subject matter may be implemented in the context of any computer-implemented system, such as a software-based system, a database system, a multi-tenant environment, or the like. Moreover, the described subject matter may be implemented in connection with two or more separate and distinct computer-implemented systems that cooperate and communicate with one another. One or more implementations may be implemented in numerous ways, including as a process, an apparatus, a system, a device, a method, a computer readable medium such as a computer readable storage medium containing computer readable instructions or computer program code, or as a computer program product comprising a computer usable medium having a computer readable program code embodied therein.

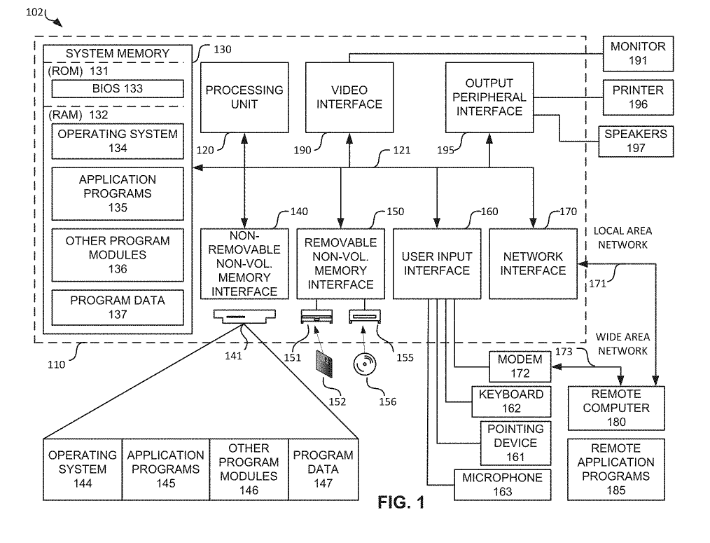

FIG. 1 is a diagram of an example client computing system that may be used with some embodiments of the invention. The computing system 102 may be used by a user to log in to an application and perform a cross repository build. For example, the user may be a developer who may be interested in updating an application having associated source code stored in multiple source repositories.

The computing system 102 is only one example of a suitable computing system, such as a mobile computing system, and is not intended to suggest any limitation as to the scope of use or functionality of the design. Neither should the computing system 102 be interpreted as having any dependency or requirement relating to any one or combination of components illustrated. The design is operational with numerous other general purpose or special purpose computing systems. Examples of well-known computing systems, environments, and/or configurations that may be suitable for use with the design include, but are not limited to, personal computers, server computers, hand-held or laptop devices, multiprocessor systems, microprocessor-based systems, set top boxes, programmable consumer electronics, mini-computers, mainframe computers, distributed computing environments that include any of the above systems or devices, and the like. For example, the computing system 102 may be implemented as a mobile computing system such as one that is configured to run with an operating system (e.g., iOS) developed by Apple Inc. of Cupertino, Calif. or an operating system (e.g., Android) that is developed by Google Inc. of Mountain View, Calif.

Some embodiments of the present invention may be described in the general context of computing system executable instructions, such as program modules, being executed by a computer. Generally, program modules include routines, programs, objects, components, data structures, etc. that performs particular tasks or implement particular abstract data types. Those skilled in the art can implement the description and/or figures herein as computer-executable instructions, which can be embodied on any form of computing machine program product discussed below.

Some embodiments of the present invention may also be practiced in distributed computing environments where tasks are performed by remote processing devices that are linked through a communications network. In a distributed computing environment, program modules may be located in both local and remote computer storage media including memory storage devices.

Referring to FIG. 1, the computing system 102 may include, but are not limited to, a processing unit 120 having one or more processing cores, a system memory 130, and a system bus 121 that couples various system components including the system memory 130 to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) locale bus, and Peripheral Component Interconnect (PCI) bus also known as Mezzanine bus.

The computing system 102 typically includes a variety of computer program product. Computer program product can be any available media that can be accessed by computing system 102 and includes both volatile and nonvolatile media, removable and non-removable media. By way of example, and not limitation, computer program product may store information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing system 102. Communication media typically embodies computer readable instructions, data structures, or program modules.

The system memory 130 may include computer storage media in the form of volatile and/or nonvolatile memory such as read only memory (ROM) 131 and random access memory (RAM) 132. A basic input/output system (BIOS) 133, containing the basic routines that help to transfer information between elements within computing system 102, such as during start-up, is typically stored in ROM 131. RAM 132 typically contains data and/or program modules that are immediately accessible to and/or presently being operated on by processing unit 120. By way of example, and not limitation, FIG. 1 also illustrates operating system 134, application programs 135, other program modules 136, and program data 137.

The computing system 102 may also include other removable/non-removable volatile/nonvolatile computer storage media. By way of example only, FIG. 1 also illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as, for example, a CD ROM or other optical media. Other removable/non-removable, volatile/nonvolatile computer storage media that can be used in the exemplary operating environment include, but are not limited to, USB drives and devices, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computing system 102. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. The operating system 144, the application programs 145, the other program modules 146, and the program data 147 are given different numeric identification here to illustrate that, at a minimum, they are different copies.

A user may enter commands and information into the computing system 102 through input devices such as a keyboard 162, a microphone 163, and a pointing device 161, such as a mouse, trackball or touch pad or touch screen. Other input devices (not shown) may include a joystick, game pad, scanner, or the like. These and other input devices are often connected to the processing unit 120 through a user input interface 160 that is coupled with the system bus 121, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computing system 102 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computing system 102. The logical connections depicted in

FIG. 1 includes a local area network (LAN) 171 and a wide area network (WAN) 173, but may also include other networks. Such networking environments are commonplace in offices, enterprise-wide computer networks, intranets and the Internet.

When used in a LAN networking environment, the computing system 102 may be connected to the LAN 171 through a network interface or adapter 170. When used in a WAN networking environment, the computing system 102 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computing system 102, or portions thereof, may be stored in a remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that some embodiments of the present invention may be carried out on a computing system such as that described with respect to FIG. 1. However, some embodiments of the present invention may be carried out on a server, a computer devoted to message handling, handheld devices, or on a distributed system in which different portions of the present design may be carried out on different parts of the distributed computing system.

Another device that may be coupled with the system bus 121 is a power supply such as a battery or a Direct Current (DC) power supply) and Alternating Current (AC) adapter circuit. The DC power supply may be a battery, a fuel cell, or similar DC power source needs to be recharged on a periodic basis. The communication module (or modem) 172 may employ a Wireless Application Protocol (WAP) to establish a wireless communication channel The communication module 172 may implement a wireless networking standard such as Institute of Electrical and Electronics Engineers (IEEE) 802.11 standard, IEEE std. 802.11-1999, published by IEEE in 1999.

Examples of mobile computing systems may be a laptop computer, a tablet computer, a Netbook, a smart phone, a personal digital assistant, or other similar device with on board processing power and wireless communications ability that is powered by a Direct Current (DC) power source that supplies DC voltage to the mobile computing system and that is solely within the mobile computing system and needs to be recharged on a periodic basis, such as a fuel cell or a battery.

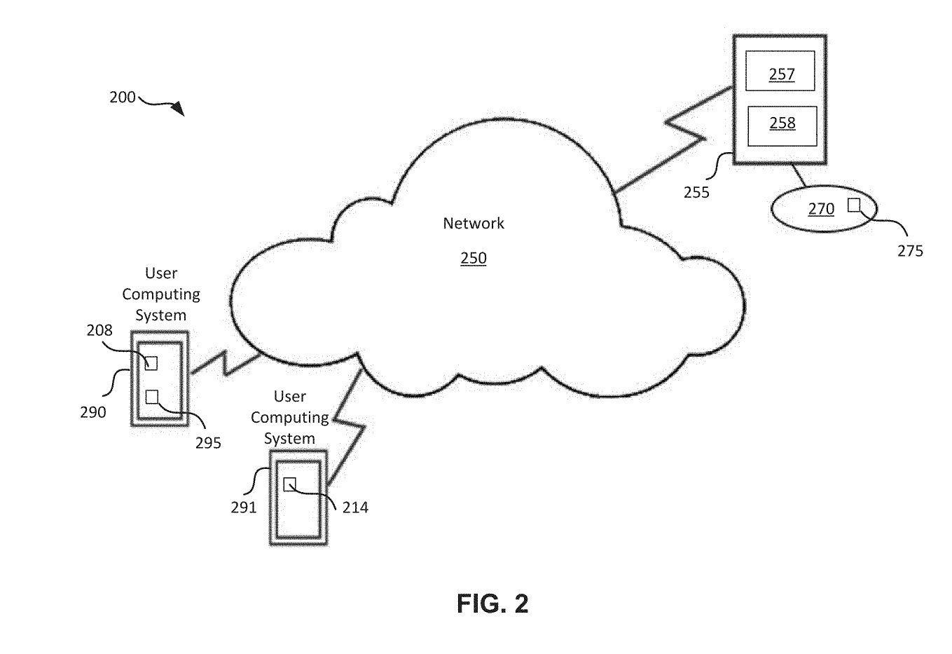

FIG. 2 shows a diagram of an example network environment that may be used with some embodiments of the invention. Network environment 200 may include client computing systems 290 and 291. One or more of the computing systems 290 and 291 may be a mobile computing system. The computing systems 290 and 291 may be connected to the network 250 via a cellular connection or via a Wi-Fi router (not shown). The network 250 may be the Internet. The computing systems 290 and 291 may be coupled with server computing system 255 via the network 250.

Each of the computing systems 290 and 291 may include a respective application module 208 and 214. A developer may use the computing system 290 and the application module 208 to communicate with the server computing system 255 and log into application 257 (e.g., a Salesforce.com® application).

The server computing system 255 may be coupled with database 270. The database 270 may be configured to include a central repository 275 which may store the source code and the binary code associated with the application 258. For example, the developer may log into the application 257 to start using the resources of the server computing system 255, including accessing the central repository 275. The central repository 275 may be shared by multiple developers to collaborate development activities relating to the application 258. A developer may use the local repository 295 to store source code and binary code for testing in a local work space.

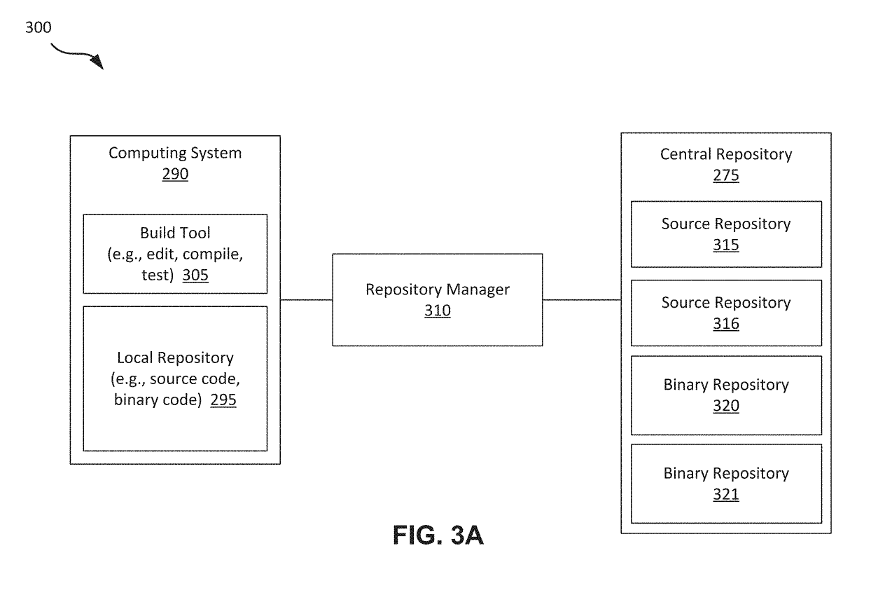

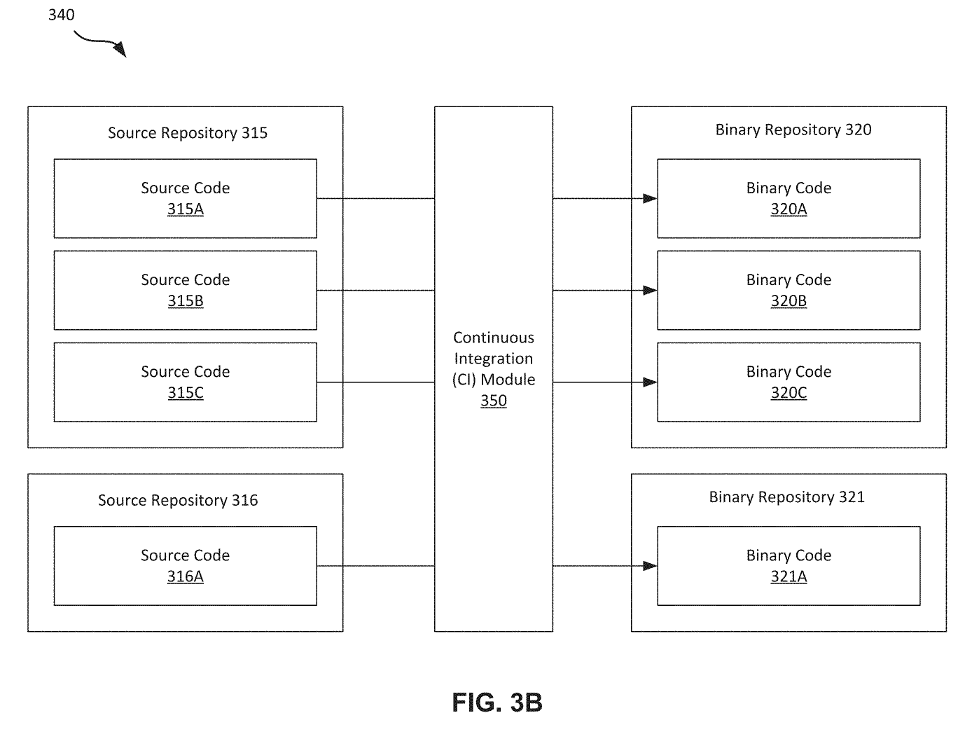

FIG. 3A is an example diagram showing multiple source repositories and multiple central binary repositories, in accordance with some embodiments. Diagram 300 includes a repository manager 310 configured to manage the central repository 275. The repository manager 310 may be a software module executing in the server computing system 255. The central repository 275 may include a first central source repository 315, a second central source repository 316, a first central binary repository 320, and a second central binary repository 321. A source code stored in the central source repository 315 or 316 may include multiple source modules, which may be stored in separate file system directories. Each module may have a unique identifier and declares on other modules which induce a module dependency graph. For some embodiments, module dependency may span from one central source repository to another central source repository. For example, a module in the central source repository 315 may be dependent on a module in the central repository 316 for it to execute properly. Similarly, a binary code stored in the central binary repository 320 or 321 may include multiple binary modules.

A developer may use a build tool 305 in the computing system 290 to generate the source code or parts of the source code using a programming language such as, for example, Java. The build tool 305 may also be used to compile the source code, create package, and install the package in the local repository 295. For example, the build tool 305 may be Maven, an open source tool that can be used to build and manage Java-based projects. Maven is a project of the Apace Software Foundation.

FIG. 3B is an example diagram showing several versions of the source code that may be stored in a source repository, in accordance with some embodiments. In a collaborative development environment, when one developer updates a source module, the updated source module may be included in one version of the source code such as, for example, source code 315A. At a later time, when another developer updates another module of the source code, the updated module may be included in another version of the source code such as, for example, source code 315D. Thus, at any given time, there may be multiple versions of the same source code. Diagram 340 shows the four source code versions 315A, 315B, 315C and 315D of the same source code in the central source repository 315 and the corresponding four binary code versions 320A, 320B, 320C and 320D of the binary code in the central binary repository 320. Diagram 340 also shows a source code version 316A in the central source repository 316 and the corresponding binary code version 321A in the central binary repository 321. Although not shown, there may also be multiple versions of the source code in the central source repository 316.

A continuous integration (CI) module 350 may be configured to deploy each version of the source code in the central source repositories 315 and 316 and deploy the binary artifacts (e.g., files in JAR format) for each of the modules of the appropriate version of the source code into the corresponding central binary repositories 320 and 321 as a version of the binary code. The CI module 350 may be included in the server computing system 255. When working with one central source repository, a developer may check out a version of the source code from the central source repository 315 or 316 into own private workspace for updates. When the update is done, the developer may commit the changes to the central source repository 315 or 316. The CI module 350 may be configured to monitor the central source repositories 315 and 316 and checks out changes when they occur. The CI module 350 may compute a checksum of each module of the source code and include the checksum in a separate metadata file for each deployed version of the source code. When deploying a new version of the source code, the CI module 350 may compare the checksums of the previously deployed artifacts with the new locally built ones. Only artifacts that have changed may be deployed. Remaining artifacts may be linked into the new version from the previous version.

In general, when a developer wants to update a module of the source code of an application (e.g., application 258), the developer may need to synchronize or get the most current version of the source code. The synchronization may include determining the most current version of the binary code in the central binary repository 320 or 321 and checking out the corresponding version of the source code in the central source repository 315 or 316. Initially, this may include downloading all the modules of the source code from the central source repository 315 or 316 to the local repository 295.

As other developers update the source code, the version of the source code stored in the local repository 295 may not be the same as the most current version stored in the central source repository 315 or 316 because they have different checksum. As such, periodic synchronization may be necessary. For example, the synchronization may be based on the developer issuing a sync command every morning at the start of a work day. Once the most current version of the source code is downloaded and stored in the local repository 295, the developer may then update the source module that needs to be updated. The build tool 305 may then be used to compile the source code and build the corresponding binary code to test the application in the local workspace.

When a developer wants to locally update and test an application using the source code from multiple central source repositories such as the central source repositories 315 and 316, it may be very difficult to manage individually downloading each source code and keeping track of how updates performed locally can be committed or published to the individual central source repository 315 or 316.

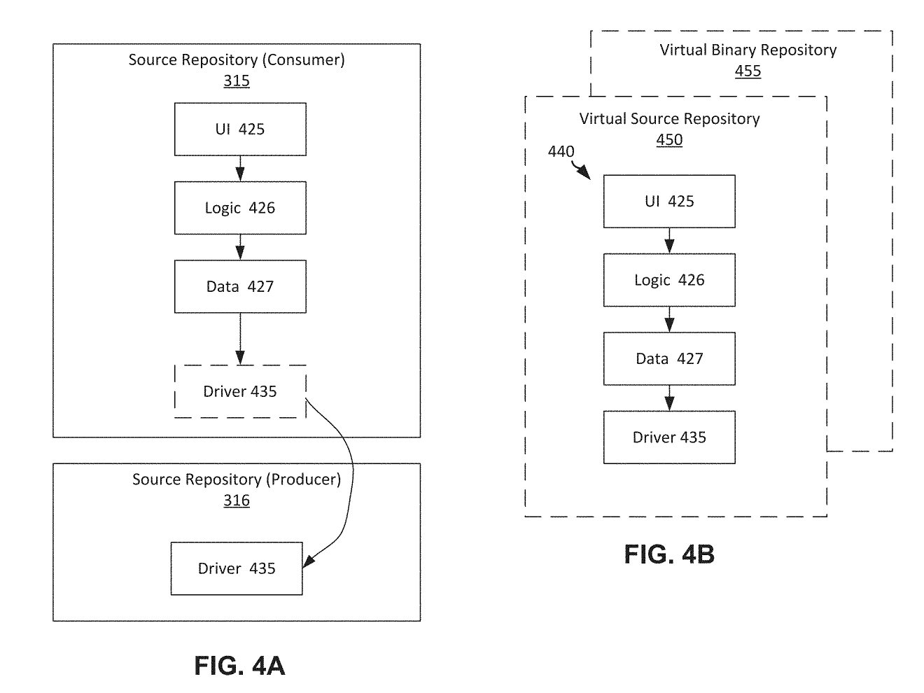

FIG. 4A is an example diagram showing module dependency, in accordance with some embodiments. A source code in the central source repository 315 may include the UI module 425, logic module 426 and data module 427. The UI module 425 is shown to be dependent on the logic module 426, and the logic module 426 is shown to be dependent on the data module 427. Dependency is shown by an arrow from one module to another module. Further, the data module 427 is shown to be dependent on the driver module 435 which is shown in dotted lines because the driver module 435 is not part of the central source repository 315. Instead, the driver module 435 is included in the central source repository 316. In this example, the central source repository 315 may be referred to as a consumer because it consumes the driver module 435, and the central source repository 316 may be referred to as a producer because it produces the driver module 435. For some embodiments, when a developer wants to work with the source code that may be in two different central source repositories, the developer may specifically include information about the two central source repositories in a request. This may include information about the specific source code modules in each of the two central source repositories.

FIG. 4B is an example of a dependency graph that includes modules from multiple central source repositories, in accordance with some embodiments. When a developer requests for the source code in two or more central source repositories, the most current version of each source code may be used. Dependencies among the modules within the same source code as well as the modules across another source code may be resolved. There may be at least one dependency. A build system may automatically identify inter-repository module dependencies and resolves them to the corresponding source code modules. A logical view of the source code modules may then be represented in a dependency graph. For example, the dependency graph 440 includes all the modules shown in FIG. 4A. For some embodiments, the modules of the source code in multiple central source repositories may be combined together using a directory structure as if they belong to the same central source repository. The graph is a logical view of a file system of the combined source code. The connectivity between the modules may reflect the location of the modules in the file system. Within each module is the source code for that module. Because the combined source code is stored in the memory, the combined source code may be viewed as being stored in a virtual source repository 450. The virtual source repository 450 may be viewed by the developer as a central source repository such as the central source repository 315. Similarly, the corresponding central binary code stored in the central binary repositories 320 and 321may be combined and stored in memory in a virtual binary repository 455.

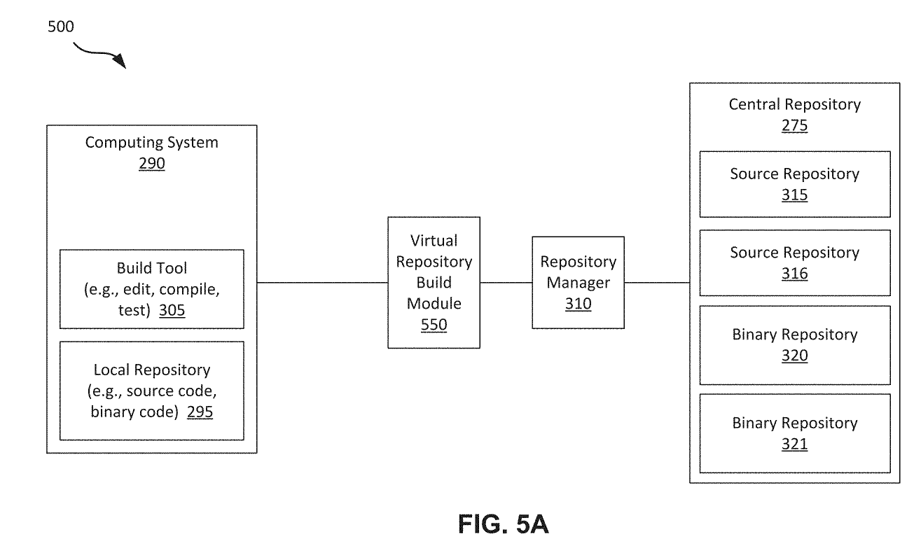

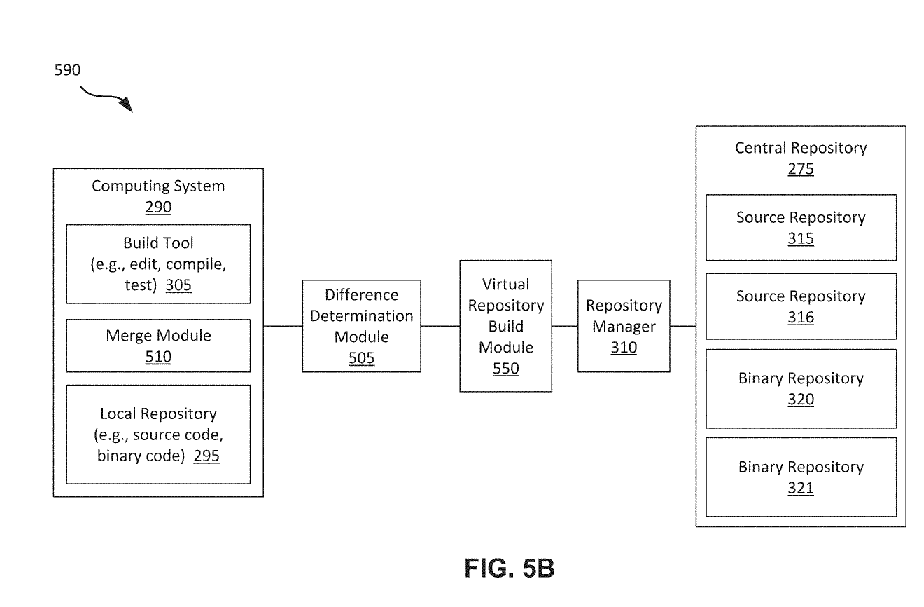

FIG. 5A is an example diagram showing a virtual repository build module, in accordance with some embodiments. Diagram 500 is similar to diagram 300 but with the addition of the virtual repository build module 505. The virtual repository build module 550 may be a software module configured to execute in the server computing system 255. The virtual repository build module 550 may be configured to combine modules in multiple source code based on module dependencies such as described in FIGS. 4A and 4B. For some embodiments, when a developer wants to get the source code from the multiple central source repositories, the developer may have to declare the central source repositories that the developer wants to work with. This may be in the form of a request. For example, the request may indicate the central source repositories 315 and 316. Based on the request, the virtual repository build module 550 may be configured to get the source code from the central source repository 315 and from the central source repository 316, combine them and build a virtual source repository in memory to keep the combined source code. The combined source code may then be downloaded to the computing system 290 and stored in the local repository 295 as if it comes from one central source repository. The developer may then use the combined source code to do development work in the local workspace.

It may be noted that the operations performed by the virtual repository build module 550 may enable the developer to work with the source code of multiple central source repositories. This is different from the conventional approach of working with multiple repositories where a developer works with the source code from one central source repository while the dependencies of the modules in that source code may be pulled in from another central binary repository in binary form. Dependencies on the binary modules may require specifying a fixed version, to identify a specific deployed artifact. The conventional approach (binary dependency with fixed version)may be well-suited for loosely-coupled repositories, i.e., repositories that can evolve mostly independently, because developers can typically change the producing source repository without rebuilding/testing the consuming source repository (stable interface). Cross-repository builds may be well-suited for tightly-coupled repositories where developers often need to rebuild/test/change the consuming repository when they make changes to the producing repository (unstable interfaces). Nevertheless, cross-repository builds can also be useful occasionally for loosely-coupled repositories. For example, if a developer knowingly makes a breaking interface change (e.g. removing a method), the developer may want to locally rebuild/-test all known consuming repositories using a cross-repository build.

FIG. 5B is an example diagram showing a difference determination module, in accordance with some embodiments. Diagram 590 is similar to diagram 500 but with the addition of the difference determination module 505. The difference determination module 505 may be a software module configured to execute in the server computing system 255. Initially, an entire copy of the combined source code and a corresponding combined binary code may be downloaded from the virtual source repository 450 and from the virtual binary repository 455. This may be based on the developer, for example, downloading the combined source code and combined binary code for the first time.

For some embodiments, the difference determination module 505 may be configured to keep track of the versions of the source code used to generate the combined source code. The difference determination module 505 may be configured to compare the combined source code previously downloaded to the local repository 295 and the most current version of the first and second source code stored in the virtual source repository 440. The difference determination module 505 may be triggered when a sync command is issued. For some embodiments, the difference determination module 505 may also be configured to compare the combined binary code with a version of each individual binary code and determine the difference. The difference may then be downloaded to the computing system 290.

The merge module 510 may be configured to reconstruct the combined source code in the local repository 295 by combining the downloaded blocks with unchanged blocks from the existing combined source code. When there are multiple blocks to be downloaded, the blocks may be downloaded in parallel. For example, a file transfer program such as zsync may be used to download a file from a remote server, where a copy of an older version of the file is already stored in the local computing system and only the new parts of the file is downloaded. Similarly, the merge module 510 may also be configured to reconstruct the combined binary code in the local repository 295 by combining the downloaded blocks with unchanged blocks from the existing combined binary code. The merge module 510 may be configured to ensure that rebuilding the combined source code results in identical corresponding combined binary code including, for example, eliminating all generated timestamps from generated JAR files. As such, the more frequently a developer issues the sync command, the lesser the difference may be, and the shorter the download times may be in order for the developer to get the most current version of the source code and binary code in the local work space. For some embodiments, the difference between two versions of the source code or binary code may be determined at the byte level, and only the bytes that have changed may be downloaded. For some embodiments, the difference may be determined at the block level, and only the blocks that have changed may be downloaded.

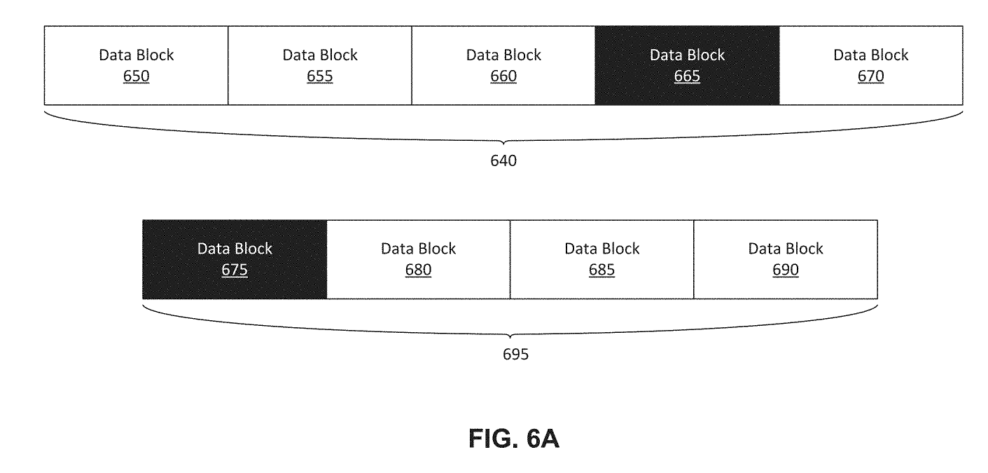

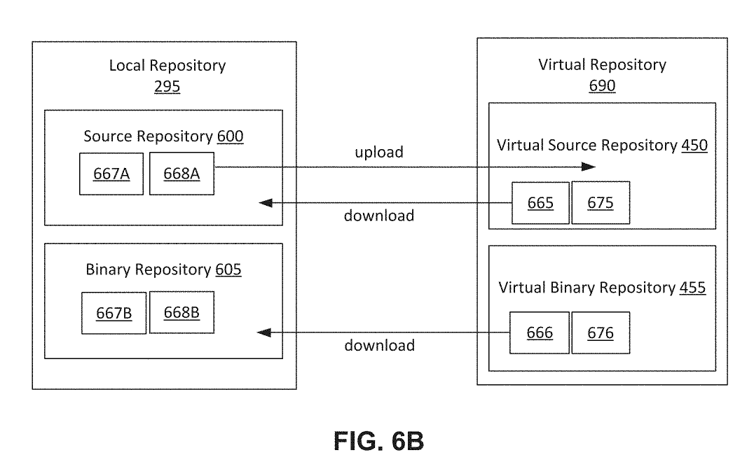

FIG. 6A shows an example of changed data blocks in different source code modules, in accordance with some embodiments. FIG. 6B shows an example of the downloading updates to the local source repository and local binary repository, in accordance with some embodiments. The data blocks 650-670 may belong to the module 640 of a most current version of a first source code of the combined source code stored in the virtual source repository 450 (shown in FIG. 4B). The data blocks 675-690 may belong to the module 695 of a most current version of a second source code of the combined source code that is stored in the virtual source repository 450. For example, each of the blocks 650-670 and 675-690 may be 4 KB in size.

When a comparison is performed of the combined source code stored in the local source repository 600 with the combined source code stored in the virtual source repository 450, it may be determined that the difference between are the blocks 665 and 675. As mentioned earlier, the block 665 may be associated with a first source code of the combined source code, and the block 675 may be associated with a second source code of the combined source code. As a result, by downloading only the data blocks 665 and 675 and updating the existing combined source code with the data blocks 665 and 675, the developer may have the most current combined source code with minimal downloading activities. Similarly, it may be determined that the data blocks 666 and 676 is the only difference between the combined binary code stored in the local binary repository 605 and the combined binary code stored in the virtual binary repository 455. As a result, by downloading only the data blocks 666 and 676 and updating the existing combined binary code with the data blocks 666 and 676, the developer may have the most current combined binary code with minimal downloading activities.

For some embodiments, a developer may need to specify or select a subset of one or more modules of the combined source code stored in the local source repository 600 that the developer wants to update. For example, the developer may manually select the module 667A and 668A of the combined source code. Alternatively, the module 667A and 668A may be automatically selected by the build tool 305 based on the files that have been edited because those files are associated with the modules 667A and 668A. For some embodiments, the developer may select to also include all modules that directly or indirectly depend on the updated modules (i.e. the transitive closure) from the modules of the combined source code. This may be useful to detect breakages in downstream modules introduced by the changes or updates.

The developer may then use the build tool 305 (shown in FIG. 5A) to invoke the build execution on the module 667A and 668A to generate corresponding binary modules 667B and 668B. The binary modules 667B and 668B may then used to update the combined binary code stored in the local binary repository 605. During build execution only source modules are built from source, and non-source module dependencies may be downloaded from the central binary repository 320. The updated combined binary code may then be used for testing in the local workspace. It may be noted that only the module 667A and 668A are used to build locally, not the entire combined source code stored in the local source repository 600. Further, it may be noted that the updated combined binary code stored in the local binary repository 605 is generated based on partially building the binary code (e.g., binary code modules 667B and 668B) while reusing the remaining of the binary code in the local binary repository 605. This may significantly improve the speed of application build.

After completion of the testing, the developer may submit the changes to the central source repository. In the example shown in FIG. and 6B, the module 667A may be associated with a first source code of the combined source code, and the module 668A may be associated with a second source code of the combined source code. As such, each of the modules 667A and 668A may need to be updated in its respective central source repository. For some embodiments, when the changes to the modules 667A and 668A are submitted, the virtual repository build module 550 (shown in FIG. 5B) may be configured to recognize which central source repository each of the modules 667A and 668A is associated with and cause the appropriate update to apply.

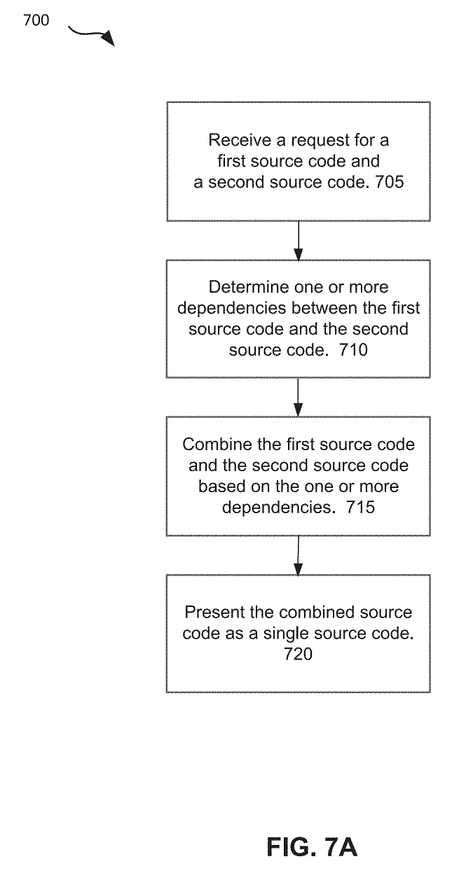

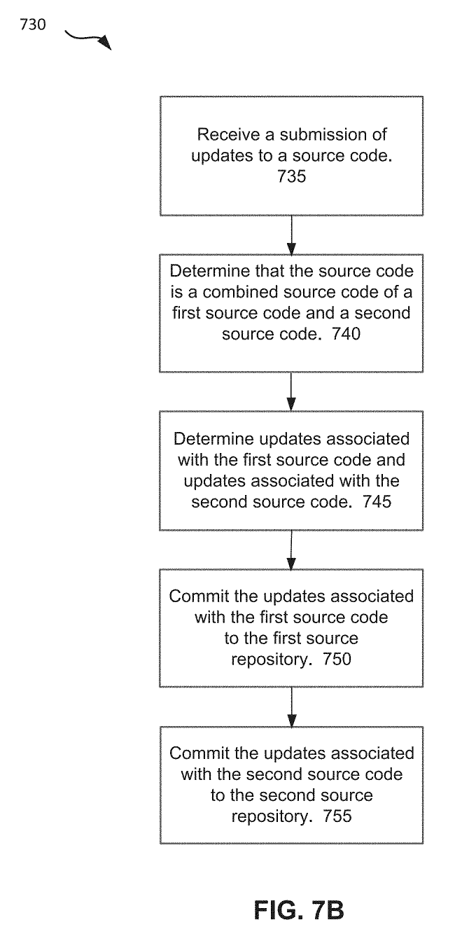

FIG. 7A shows a flowchart of an example process for performing cross repository build, in accordance with some embodiments. The example process 700 may be performed by a virtual repository build module 550 (shown in FIG. 5B) which may be in the server computing system 255. A developer may declare the need for two source code in a request. The first source code may be associated with a first central source repository. The second source code may be associated with a second central source repository. The request may be received by the virtual repository build module 550, as shown in block 705. At block 710, the virtual repository build module 550 may determine one or more dependencies among the modules of the first source code and the second source code. At block 715, the virtual repository build module 550 may combine the first source code with the second source code based on the determined dependencies. At block 720, the combined source code may be presented to the developer as a single source code. The combined source code may be downloaded to a computing system used by the developer to perform development work in a local workspace.

FIG. 7B shows another flowchart of an example process for performing cross repository build, in accordance with some embodiments. The example process 730 may be performed by a virtual repository build module 550. The process 730 may be initiated when a developer completes testing of a combined source code in a local work space and submit changes associated with the combined source code to the central source repository. At block 735, the submission of the changes may be received by the virtual repository build module 550. At block 740, the virtual repository build module 550 may determine that the changes are associated with a combined source code including a first source code and a second source code. At block 745, the virtual repository build module 550 may determine parts of the updates that are associated with the first source code and parts of the updates that are associated with the second source code. At block 750, the updates associated with the first source code are committed to the first source repository. At block 755, the updates associated with the second source code are committed to the second source repository.

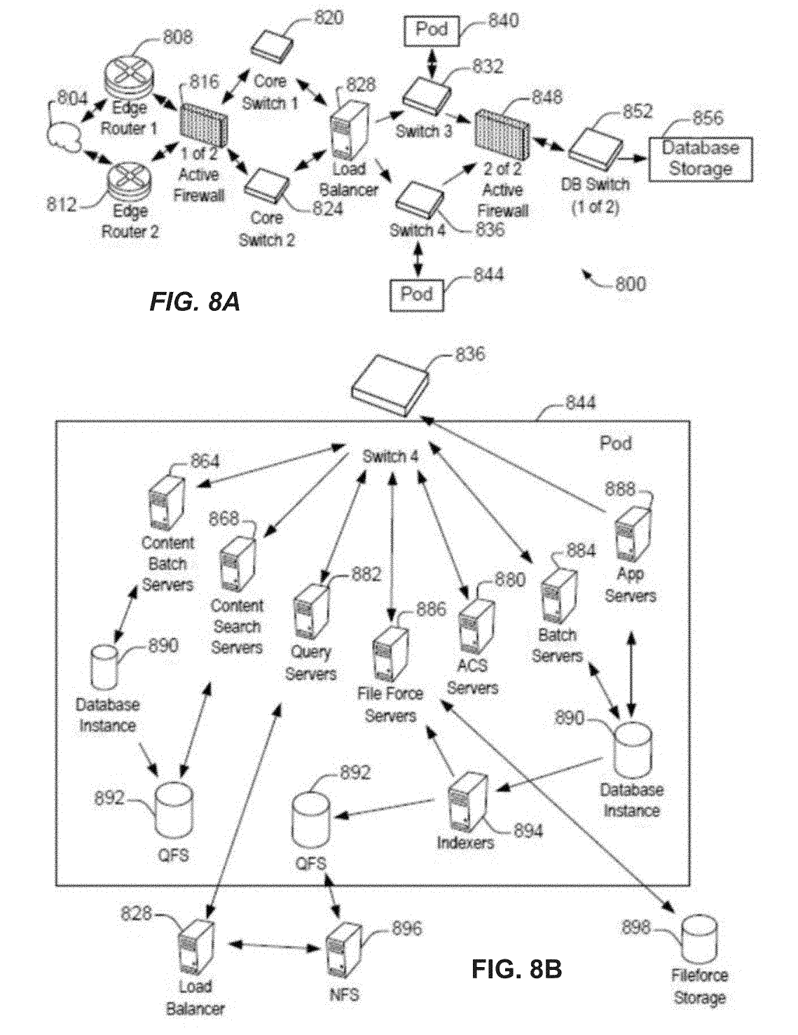

FIG. 8A shows a system diagram 800 illustrating architectural components of an on-demand service environment, in accordance with some embodiments. A client machine located in the cloud 804 (or Internet) may communicate with the on-demand service environment via one or more edge routers 808 and 812. The edge routers may communicate with one or more core switches 820 and 824 via firewall 816. The core switches may communicate with a load balancer 828, which may distribute server load over different pods, such as the pods 840 and 844. The pods 840 and 844, which may each include one or more servers and/or other computing resources, may perform data processing and other operations used to provide on-demand services. Communication with the pods may be conducted via pod switches 832 and 836. Components of the on-demand service environment may communicate with a database storage system 856 via a database firewall 848 and a database switch 852.

As shown in FIGS. 8A and 8B, accessing an on-demand service environment may involve communications transmitted among a variety of different hardware and/or software components. Further, the on-demand service environment 800 is a simplified representation of an actual on-demand service environment. For example, while only one or two devices of each type are shown in FIGS. 8A and 8B, some embodiments of an on-demand service environment may include anywhere from one to many devices of each type. Also, the on-demand service environment need not include each device shown in FIGS. 8A and 8B, or may include additional devices not shown in FIGS. 8A and 8B.

Moreover, one or more of the devices in the on-demand service environment 800 may be implemented on the same physical device or on different hardware. Some devices may be implemented using hardware or a combination of hardware and software. Thus, terms such as “data processing apparatus,” “machine,” “server” and “device” as used herein are not limited to a single hardware device, but rather include any hardware and software configured to provide the described functionality.

The cloud 804 is intended to refer to a data network or plurality of data networks, often including the Internet. Client machines located in the cloud 804 may communicate with the on-demand service environment to access services provided by the on-demand service environment. For example, client machines may access the on-demand service environment to retrieve, store, edit, and/or process information.

In some embodiments, the edge routers 808 and 812 route packets between the cloud 804 and other components of the on-demand service environment 800. The edge routers 808 and 812 may employ the Border Gateway Protocol (BGP). The BGP is the core routing protocol of the Internet. The edge routers 808 and 812 may maintain a table of IP networks or ‘prefixes’ which designate network reachability among autonomous systems on the Internet.

In one or more embodiments, the firewall 816 may protect the inner components of the on-demand service environment 800 from Internet traffic. The firewall 816 may block, permit, or deny access to the inner components of the on-demand service environment 800 based upon a set of rules and other criteria. The firewall 816 may act as one or more of a packet filter, an application gateway, a stateful filter, a proxy server, or any other type of firewall.

In some embodiments, the core switches 820 and 824 are high-capacity switches that transfer packets within the on-demand service environment 800. The core switches 820 and 824 may be configured as network bridges that quickly route data between different components within the on-demand service environment. In some embodiments, the use of two or more core switches 820 and 824 may provide redundancy and/or reduced latency.

In some embodiments, the pods 840 and 844 may perform the core data processing and service functions provided by the on-demand service environment. Each pod may include various types of hardware and/or software computing resources. An example of the pod architecture is discussed in greater detail with reference to FIG. 8B.

In some embodiments, communication between the pods 840 and 844 may be conducted via the pod switches 832 and 836. The pod switches 832 and 836 may facilitate communication between the pods 840 and 844 and client machines located in the cloud 804, for example via core switches 820 and 824. Also, the pod switches 832 and 836 may facilitate communication between the pods 840 and 844 and the database storage 856.

In some embodiments, the load balancer 828 may distribute workload between the pods 840 and 844. Balancing the on-demand service requests between the pods may assist in improving the use of resources, increasing throughput, reducing response times, and/or reducing overhead. The load balancer 828 may include multilayer switches to analyze and forward traffic.

In some embodiments, access to the database storage 856 may be guarded by a database firewall 848. The database firewall 848 may act as a computer application firewall operating at the database application layer of a protocol stack. The database firewall 848 may protect the database storage 856 from application attacks such as structure query language (SQL) injection, database rootkits, and unauthorized information disclosure.

In some embodiments, the database firewall 848 may include a host using one or more forms of reverse proxy services to proxy traffic before passing it to a gateway router. The database firewall 848 may inspect the contents of database traffic and block certain content or database requests. The database firewall 848 may work on the SQL application level atop the TCP/IP stack, managing applications' connection to the database or SQL management interfaces as well as intercepting and enforcing packets traveling to or from a database network or application interface.

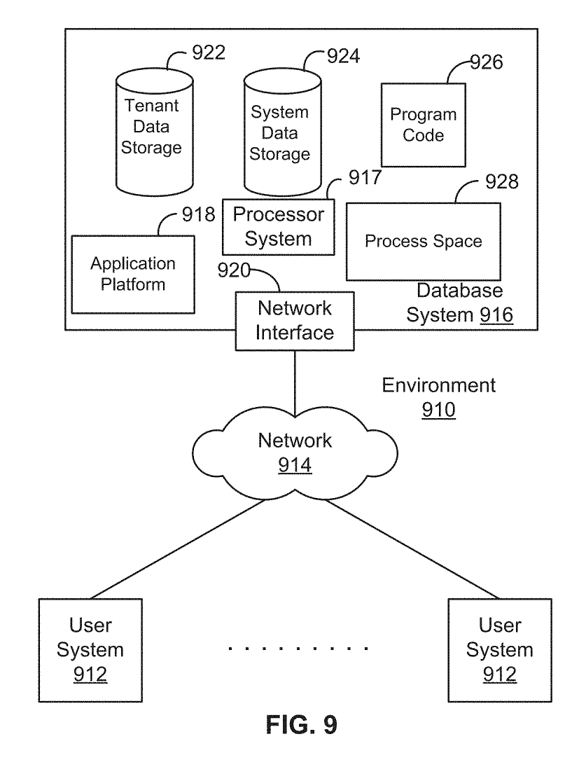

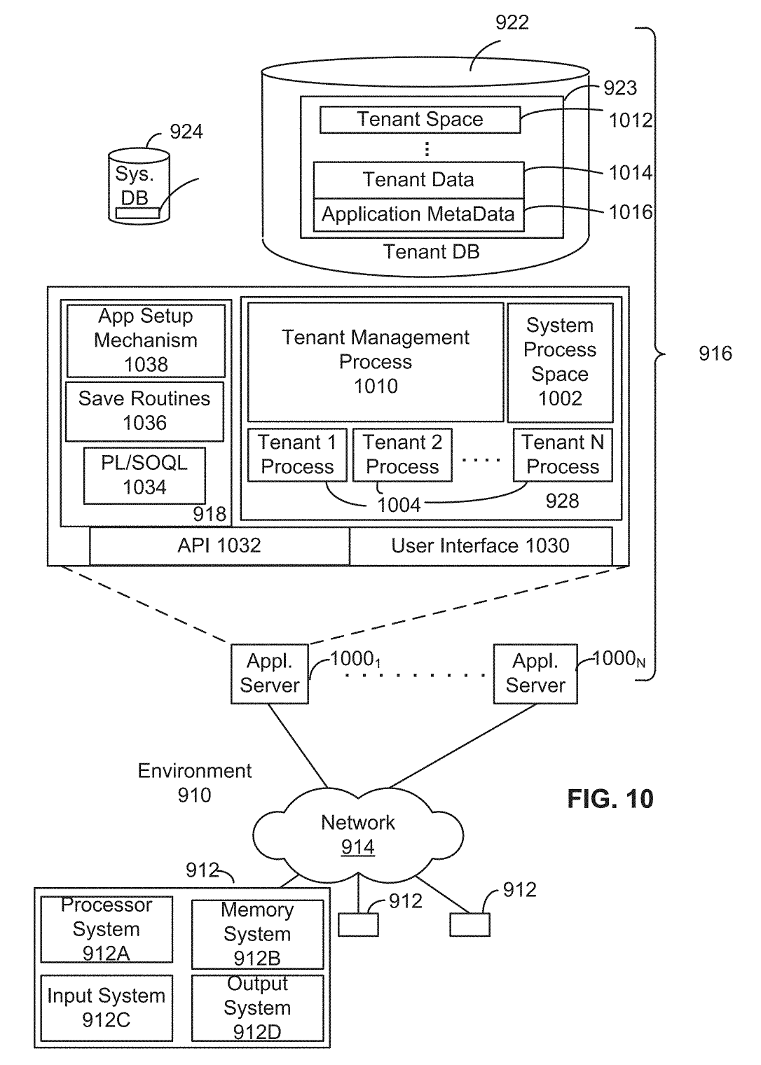

In some embodiments, communication with the database storage system 856 may be conducted via the database switch 852. The multi-tenant database system 856 may include more than one hardware and/or software components for handling database queries. Accordingly, the database switch 852 may direct database queries transmitted by other components of the on-demand service environment (e.g., the pods 840 and 844) to the correct components within the database storage system 856. In some embodiments, the database storage system 856 is an on-demand database system shared by many different organizations. The on-demand database system may employ a multi-tenant approach, a virtualized approach, or any other type of database approach. An on-demand database system is discussed in greater detail with reference to FIGS. 9 and 10.

FIG. 8B shows a system diagram illustrating the architecture of the pod 844, in accordance with one embodiment. The pod 844 may be used to render services to a user of the on-demand service environment 800. In some embodiments, each pod may include a variety of servers and/or other systems. The pod 844 includes one or more content batch servers 864, content search servers 868, query servers 872, file force servers 876, access control system (ACS) servers 880, batch servers 884, and app servers 888. Also, the pod 844 includes database instances 890, quick file systems (QFS) 892, and indexers 894. In one or more embodiments, some or all communication between the servers in the pod 844 may be transmitted via the switch 836.

In some embodiments, the application servers 888 may include a hardware and/or software framework dedicated to the execution of procedures (e.g., programs, routines, scripts) for supporting the construction of applications provided by the on-demand service environment 800 via the pod 844. Some such procedures may include operations for providing the services described herein. The content batch servers 864 may requests internal to the pod. These requests may be long-running and/or not tied to a particular customer. For example, the content batch servers 864 may handle requests related to log mining, cleanup work, and maintenance tasks.

The content search servers 868 may provide query and indexer functions. For example, the functions provided by the content search servers 868 may allow users to search through content stored in the on-demand service environment. The Fileforce servers 876 may manage requests information stored in the Fileforce storage 878. The Fileforce storage 878 may store information such as documents, images, and basic large objects (BLOBs). By managing requests for information using the Fileforce servers 876, the image footprint on the database may be reduced.

The query servers 872 may be used to retrieve information from one or more file systems. For example, the query system 872 may receive requests for information from the app servers 888 and then transmit information queries to the NFS 896 located outside the pod. The pod 844 may share a database instance 890 configured as a multi-tenant environment in which different organizations share access to the same database. Additionally, services rendered by the pod 844 may require various hardware and/or software resources. In some embodiments, the ACS servers 880 may control access to data, hardware resources, or software resources.

In some embodiments, the batch servers 884 may process batch jobs, which are used to run tasks at specified times. Thus, the batch servers 884 may transmit instructions to other servers, such as the app servers 888, to trigger the batch jobs. For some embodiments, the QFS 892 may be an open source file system available from Sun Microsystems® of Santa Clara, Calif. The QFS may serve as a rapid-access file system for storing and accessing information available within the pod 844. The QFS 892 may support some volume management capabilities, allowing many disks to be grouped together into a file system. File system metadata can be kept on a separate set of disks, which may be useful for streaming applications where long disk seeks cannot be tolerated. Thus, the QFS system may communicate with one or more content search servers 868 and/or indexers 894 to identify, retrieve, move, and/or update data stored in the network file systems 896 and/or other storage systems.

In some embodiments, one or more query servers 872 may communicate with the NFS 896 to retrieve and/or update information stored outside of the pod 844. The NFS 896 may allow servers located in the pod 844 to access information to access files over a network in a manner similar to how local storage is accessed. In some embodiments, queries from the query servers 822 may be transmitted to the NFS 896 via the load balancer 820, which may distribute resource requests over various resources available in the on-demand service environment. The NFS 896 may also communicate with the QFS 892 to update the information stored on the NFS 896 and/or to provide information to the QFS 892 for use by servers located within the pod 844.

In some embodiments, the pod may include one or more database instances 890. The database instance 890 may transmit information to the QFS 892. When information is transmitted to the QFS, it may be available for use by servers within the pod 844 without requiring an additional database call. In some embodiments, database information may be transmitted to the indexer 894. Indexer 894 may provide an index of information available in the database 890 and/or QFS 892. The index information may be provided to file force servers 876 and/or the QFS 892.

FIG. 9 shows a block diagram of an environment 910 wherein an on-demand database service might be used, in accordance with some embodiments. Environment 910 includes an on-demand database service 916. User system 912 may be any machine or system that is used by a user to access a database user system. For example, any of user systems 912 can be a handheld computing system, a mobile phone, a laptop computer, a work station, and/or a network of computing systems. As illustrated in FIGS. 9 and 10, user systems 912 might interact via a network 914 with the on-demand database service 916.

An on-demand database service, such as system 916, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 916” and “system 916” will be used interchangeably herein. A database image may include one or more database objects. A relational database management system (RDBMS) or the equivalent may execute storage and retrieval of information against the database object(s). Application platform 918 may be a framework that allows the applications of system 916 to run, such as the hardware and/or software, e.g., the operating system. In an implementation, on-demand database service 916 may include an application platform 918 that enables creation, managing and executing one or more applications developed by the provider of the on-demand database service, users accessing the on-demand database service via user systems 912, or third party application developers accessing the on-demand database service via user systems 912.

One arrangement for elements of system 916 is shown in FIG. 9, including a network interface 920, application platform 918, tenant data storage 922 for tenant data 923, system data storage 924 for system data 925 accessible to system 916 and possibly multiple tenants, program code 926 for implementing various functions of system 916, and a process space 928 for executing MTS system processes and tenant-specific processes, such as running applications as part of an application hosting service. Additional processes that may execute on system 916 include database indexing processes.

The users of user systems 912 may differ in their respective capacities, and the capacity of a particular user system 912 might be entirely determined by permissions (permission levels) for the current user. For example, where a call center agent is using a particular user system 912 to interact with system 916, the user system 912 has the capacities allotted to that call center agent. However, while an administrator is using that user system to interact with system 916, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users may have different capabilities with regard to accessing and modifying application and database information, depending on a user's security or permission level.

Network 914 is any network or combination of networks of devices that communicate with one another. For example, network 914 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network (e.g., the Internet), that network will be used in many of the examples herein. However, it should be understood that the networks used in some embodiments are not so limited, although TCP/IP is a frequently implemented protocol.

User systems 912 might communicate with system 916 using TCP/IP and, at a higher network level, use other common Internet protocols to communicate, such as HTTP, FTP, AFS, WAP, etc. In an example where HTTP is used, user system 912 might include an HTTP client commonly referred to as a “browser” for sending and receiving HTTP messages to and from an HTTP server at system 916. Such an HTTP server might be implemented as the sole network interface between system 916 and network 914, but other techniques might be used as well or instead. In some embodiments, the interface between system 916 and network 914 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In some embodiments, system 916, shown in FIG. 9, implements a web-based customer relationship management (CRM) system. For example, in some embodiments, system 916 includes application servers configured to implement and execute CRM software applications as well as provide related data, code, forms, web pages and other information to and from user systems 912 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 916 implements applications other than, or in addition to, a CRM application. For example, system 916 may provide tenant access to multiple hosted (standard and custom) applications. User (or third party developer) applications, which may or may not include CRM, may be supported by the application platform 918, which manages creation, storage of the applications into one or more database objects and executing of the applications in a virtual machine in the process space of the system 916.

Each user system 912 could include a desktop personal computer, workstation, laptop, PDA, cell phone, or any wireless access protocol (WAP) enabled device or any other computing system capable of interfacing directly or indirectly to the Internet or other network connection. User system 912 typically runs an HTTP client, e.g., a browsing program, such as Microsoft's Internet Explorer® browser, Mozilla's Firefox® browser, Opera's browser, or a WAP-enabled browser in the case of a cell phone, PDA or other wireless device, or the like, allowing a user (e.g., subscriber of the multi-tenant database system) of user system 912 to access, process and view information, pages and applications available to it from system 916 over network 914.

Each user system 912 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 916 or other systems or servers. For example, the user interface device can be used to access data and applications hosted by system 916, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to some embodiments, each user system 912 and all of its components are operator configurable using applications, such as a browser, including computer code run using a central processing unit such as an Intel Pentium® processor or the like. Similarly, system 916 (and additional instances of an MTS, where more than one is present) and all of their components might be operator configurable using application(s) including computer code to run using a central processing unit such as processor system 917, which may include an Intel Pentium® processor or the like, and/or multiple processor units.

A computer program product implementation includes a machine-readable storage medium (media) having instructions stored thereon/in which can be used to program a computer to perform any of the processes of the embodiments described herein. Computer code for operating and configuring system 916 to intercommunicate and to process web pages, applications and other data and media content as described herein are preferably downloaded and stored on a hard disk, but the entire program code, or portions thereof, may also be stored in any other volatile or non-volatile memory medium or device, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, or transmitted over any other conventional network connection (e.g., extranet, VPN, LAN, etc.) using any communication medium and protocols (e.g., TCP/IP, HTTP, HTTPS, Ethernet, etc.). It will also be appreciated that computer code for implementing embodiments can be implemented in any programming language that can be executed on a client system and/or server or server system such as, for example, C, C++, HTML, any other markup language, Java™, JavaScript®, ActiveX®, any other scripting language, such as VBScript, and many other programming languages as are well known may be used. (Java™ is a trademark of Sun Microsystems®, Inc.).

According to some embodiments, each system 916 is configured to provide web pages, forms, applications, data and media content to user (client) systems 912 to support the access by user systems 912 as tenants of system 916. As such, system 916 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include logically and/or physically connected servers distributed locally or across one or more geographic locations. Additionally, the term “server” is meant to include a computing system, including processing hardware and process space(s), and an associated storage system and database application (e.g., OODBMS or RDBMS) as is well known in the art.

It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 10 also shows a block diagram of environment 910 further illustrating system 916 and various interconnections, in accordance with some embodiments. FIG. 10 shows that user system 912 may include processor system 912A, memory system 912B, input system 912C, and output system 912D. FIG. 10 shows network 914 and system 916. FIG. 10 also shows that system 916 may include tenant data storage 922, tenant data 923, system data storage 924, system data 925, User Interface (UI) 1030, Application Program Interface (API) 1032, PL/SOQL 1034, save routines 1036, application setup mechanism 1038, applications servers 10001-1000N, system process space 1002, tenant process spaces 1004, tenant management process space 1010, tenant storage area 1012, user storage 1014, and application metadata 1016. In other embodiments, environment 910 may not have the same elements as those listed above and/or may have other elements instead of, or in addition to, those listed above.

User system 912, network 914, system 916, tenant data storage 922, and system data storage 924 were discussed above in FIG. 9. Regarding user system 912, processor system 912A may be any combination of processors. Memory system 912B may be any combination of one or more memory devices, short term, and/or long term memory. Input system 912C may be any combination of input devices, such as keyboards, mice, trackballs, scanners, cameras, and/or interfaces to networks. Output system 912D may be any combination of output devices, such as monitors, printers, and/or interfaces to networks. As shown by FIG. 10, system 916 may include a network interface 920 (of FIG. 9) implemented as a set of HTTP application servers 1000, an application platform 918, tenant data storage 922, and system data storage 924. Also shown is system process space 1002, including individual tenant process spaces 1004 and a tenant management process space 1010. Each application server 1000 may be configured to tenant data storage 922 and the tenant data 923 therein, and system data storage 924 and the system data 925 therein to serve requests of user systems 912. The tenant data 923 might be divided into individual tenant storage areas 1012, which can be either a physical arrangement and/or a logical arrangement of data. Within each tenant storage area 1012, user storage 1014 and application metadata 1016 might be similarly allocated for each user. For example, a copy of a user's most recently used (MRU) items might be stored to user storage 1014. Similarly, a copy of MRU items for an entire organization that is a tenant might be stored to tenant storage area 1012. A UI 1030 provides a user interface and an API 1032 provides an application programmer interface to system 916 resident processes to users and/or developers at user systems 912. The tenant data and the system data may be stored in various databases, such as Oracle™ databases.

Application platform 918 includes an application setup mechanism 1038 that supports application developers' creation and management of applications, which may be saved as metadata into tenant data storage 922 by save routines 1036 for execution by subscribers as tenant process spaces 1004 managed by tenant management process 1010 for example. Invocations to such applications may be coded using PL/SOQL 34 that provides a programming language style interface extension to API 1032. A detailed description of some PL/SOQL language embodiments is discussed in commonly assigned U.S. Pat. No. 7,730,478, titled METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 4007, which is hereby incorporated by reference in its entirety and for all purposes. Invocations to applications may be detected by system processes, which manage retrieving application metadata 1016 for the subscriber making the invocation and executing the metadata as an application in a virtual machine.

Each application server 1000 may be communicably coupled to database systems, e.g., having access to system data 925 and tenant data 923, via a different network connection. For example, one application server 10001 might be coupled via the network 914 (e.g., the Internet), another application server 1000N-1 might be coupled via a direct network link, and another application server 1000N might be coupled by yet a different network connection. Transfer Control Protocol and Internet Protocol (TCP/IP) are typical protocols for communicating between application servers 1000 and the database system. However, other transport protocols may be used to optimize the system depending on the network interconnect used.

In certain embodiments, each application server 1000 is configured to handle requests for any user associated with any organization that is a tenant. Because it is desirable to be able to add and remove application servers from the server pool at any time for any reason, there is preferably no server affinity for a user and/or organization to a specific application server 1000. In some embodiments, therefore, an interface system implementing a load balancing function (e.g., an F5 Big-IP load balancer) is communicably coupled between the application servers 1000 and the user systems 912 to distribute requests to the application servers 1000. In some embodiments, the load balancer uses a least connections algorithm to route user requests to the application servers 1000. Other examples of load balancing algorithms, such as round robin and observed response time, also can be used. For example, in certain embodiments, three consecutive requests from the same user could hit three different application servers 1000, and three requests from different users could hit the same application server 1000. In this manner, system 916 is multi-tenant, wherein system 916 handles storage of, and access to, different objects, data and applications across disparate users and organizations.

As an example of storage, one tenant might be a company that employs a sales force where each call center agent uses system 916 to manage their sales process. Thus, a user might maintain contact data, leads data, customer follow-up data, performance data, goals and progress data, etc., all applicable to that user's personal sales process (e.g., in tenant data storage 922). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a call center agent is visiting a customer and the customer has Internet access in their lobby, the call center agent can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 916 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 916 might also maintain system level data usable by multiple tenants or other data. Such system level data might include industry reports, news, postings, and the like that are sharable among tenants.

In certain embodiments, user systems 912 (which may be client machines/systems) communicate with application servers 1000 to request and update system-level and tenant-level data from system 916 that may require sending one or more queries to tenant data storage 922 and/or system data storage 924. System 916 (e.g., an application server 1000 in system 916) automatically generates one or more SQL statements (e.g., SQL queries) that are designed to access the desired information. System data storage 924 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects according to some embodiments. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for account, contact, lead, and opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, titled CUSTOM ENTITIES AND FIELDS IN A MULTI-TENANT DATABASE SYSTEM, by Weissman, et al., and which is hereby incorporated by reference in its entirety and for all purposes, teaches systems and methods for creating custom objects as well as customizing standard objects in a multi-tenant database system. In some embodiments, for example, all custom entity data rows are stored in a single multi-tenant physical table, which may contain multiple logical tables per organization. In some embodiments, multiple “tables” for a single customer may actually be stored in one large table and/or in the same table as the data of other customers.

These and other aspects of the disclosure may be implemented by various types of hardware, software, firmware, etc. For example, some features of the disclosure may be implemented, at least in part, by machine-program product that include program instructions, state information, etc., for performing various operations described herein. Examples of program instructions include both machine code, such as produced by a compiler, and files containing higher-level code that may be executed by the computer using an interpreter. Examples of machine-program product include, but are not limited to, magnetic media such as hard disks, floppy disks, and magnetic tape; optical media such as CD-ROM disks; magneto-optical media; and hardware devices that are specially configured to store and perform program instructions, such as read-only memory devices (“ROM”) and random access memory (“RAM”).

While one or more embodiments and techniques are described with reference to an implementation in which a service cloud console is implemented in a system having an application server providing a front end for an on-demand database service capable of supporting multiple tenants, the one or more embodiments and techniques are not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While various embodiments have been described herein, it should be understood that they have been presented by way of example only, and not limitation. Thus, the breadth and scope of the present application should not be limited by any of the embodiments described herein, but should be defined only in accordance with the following and later-submitted claims and their equivalents.

What is claimed is:

1. A method comprising:
receiving, by a server computing system, a first request from a client computing system for first source code stored in a first central source repository and second source code stored in a second central source repository;
generating, by the server computing system, combined source code using the first source code and the second source code, the generating being based on at least one dependency between a source code module in the first source code and a source code module in the second source code; and
causing, by the server computing system, one or more source code modules in the combined source code to be transmitted to the client computing system in response to the first request.

2. The method of claim 1, further comprising:
resolving, by the server computing system, the at least one dependency between the source code module in the first source code and the source code module in the second source code; and
keeping track, by the server computing system, of whether a source code module in the combined source code belongs to the first source code or the second source code.

3. The method of claim 2, further comprising receiving, by the server computing system, a second request from the client computing system to commit one or more updates to the combined source code.

4. The method of claim 3, wherein the second request is to update at least one source code module of the combined source code.

5. The method of claim 4, further comprising updating, by the server computing system, the first source code based on the request to update the at least one source code module of the combined source code includes at least one source code module associated with the first source code.

6. The method of claim 5, further comprising updating, by the server computing system, the second source code based on the request to update the at least one source code module of the combined source code includes at least one source code module associated with the second source code.

7. The method of claim 2, further comprising:
generating, by the server computing system, combined binary code using first binary code and second binary code based on the combined source code, the first binary code stored in a first central binary repository and corresponding to the first source code, and the second binary code stored in a second central binary repository and corresponding to the second source code; and
causing, by the server computing system, one or more binary code modules in the combined binary code to be transmitted to the client computing system in response to the first request.

8. An apparatus comprising:
one or more processors; and
a non-transitory computer readable medium storing a plurality of instructions, which when executed, cause the one or more processors to:
receive a first request from a client computing system for first source code stored in a first central source repository and second source code stored in a second central source repository;
generate a combined source code using the first source code and the second source code, said generating being based on at least one dependency between a source code module in the first source code and a source code module in the second source code; and
cause one or more source code modules in the combined source code to be transmitted to the client computing system in response to the first request.

9. The apparatus of claim 8, further comprising instructions to:
resolve the at least one dependency between the source code module in the first source code and the source code module in the second source code; and
keep track of whether a source code module in the combined source code belongs to the first source code or the second source code.

10. The apparatus of claim 9, further comprising instructions to receive a second request from the client computing system to commit one or more updates to the combined source code.

11. The apparatus of claim 10, wherein the second request is to update at least one source code module of the combined source code.

12. The apparatus of claim 11, further comprising instructions to update the first source code based on the request to update the at least one source code module of the combined source code includes at least one source code module associated with the first source code.

13. The apparatus of claim 12, further comprising instructions to update the second source code based on the request to update the at least one source code module of the combined source code includes at least one source code module associated with the second source code.

14. The apparatus of claim 9, further comprising instructions to:
generate combined binary code using first binary code and second binary code based on the combined source code, the first binary code stored in a first central binary repository and corresponding to the first source code, and the second binary code stored in a second central binary repository and corresponding to the second source code; and
cause one or more binary code modules in the combined binary code to be transmitted to the client computing system in response to the first request.

15. A computer program product comprising computer-readable program code to be executed by one or more processors when retrieved from a non-transitory computer-readable medium, the program code including instructions to:
receive a first request from a client computing system for first source code stored in a first central source repository and second source code stored in a second central source repository;
generate combined source code using the first source code and the second source code, said generating being based on at least one dependency between a source code module in the first source code and a source code module in the second source code; and
cause one or more source code modules in the combined source code to be transmitted to the client computing system in response to the first request.

16. The computer program product of claim 15, further comprising instructions to:
resolve the at least one dependency between the source code module in the first source code and the source code module in the second source code; and
keep track of whether a source code module in the combined source code belongs to the first source code or the second source code.

17. The computer program product of claim 16, further comprising instructions to receive a second request from the client computing system to commit one or more updates to the combined source code.

18. The computer program product of claim 17, wherein the second request is to update at least one source code module of the combined source code.

19. The computer program product of claim 18, further comprising instructions to update the first source code based on the request to update the at least one source code module of the combined source code includes at least one source code module associated with the first source code.

20. The computer program product of claim 19, further comprising instructions to update the second source code based on the request to update the at least one source code module of the combined source code includes at least one source code module associated with the second source code.

21. The computer program product of claim 16, further comprising instructions to:
generate a combined binary code using a first binary code and a second binary code based on the combined source code, the first binary code stored in a first central binary repository and corresponding to the first source code, and the second binary code stored in a second central binary repository and corresponding to the second source code; and
cause one or more binary code modules in the combined binary code to be transmitted to the client computing system in response to the first request.
